(19) United States
(12) Patent Application Publication
(10) Pub. No.: US 2026/0148359 A1
(43) Pub. Date: May 28, 2026

(54) INFORMATION PROCESSING METHOD AND INFORMATION PROCESSING APPARATUS

(71) Applicant: Panasonic Intellectual Property Management Co., Ltd., Osaka (JP)

(72) Inventors: SATOSHI SATO, Kyoto (JP); HIDENOBU YAKU, Osaka (JP); ATSUSHI ISHIKAWA, Osaka (JP)

(21) Appl. No.: 19/453,441

(22) Filed: Jan. 20, 2026

Related U.S. Application Data
(63) Continuation of application No. PCT/JP2024/024550, filed on Jul. 8, 2024.

(30) Foreign Application Priority Data
Aug. 3, 2023 (JP) 2023-127308

(51) Int. Cl. G06T 7/00; G06F 3/04845

(52) U.S. Cl. CPC G06T 7/0002; G06F 3/04845

(57) ABSTRACT

An information processing method executed by a computer includes acquiring a compressed image including pixels each having data including information on four or more wavelength bands, acquiring image quality adjustment information for adjusting image quality of four or more spectral images that are generated by executing reconstruction calculation based on the compressed image and correspond to the four or more wavelength bands, respectively, determining one or more values of one or more arithmetic parameters used in the reconstruction calculation on the basis of the image quality adjustment information, and generating the four or more spectral images by executing the reconstruction calculation on the compressed image by using the determined values of the arithmetic parameters.

### BACKGROUND

### 1. Technical Field

The present disclosure relates to an information processing method and an information processing apparatus.

### 2. Description of the Related Art

A technique of applying compressed sensing to a camera that takes a hyperspectral image having spectral information in more wavelength bands (four or more wavelength bands) than red, green, and blue has been proposed. The compressed sensing is a technique for generating a larger number of data from acquired data including a smaller number of samples. For example, in International Publication No. 2021/192891 (hereinafter referred to as Patent Literature 1) and Japanese Patent No. 7262003 (hereinafter referred to as Patent Literature 2), a compressed image is taken by using a filter array including filters having different wavelength dependences, and four or more spectral images (hyperspectral image) that correspond to four or more wavelength bands on one-to-one basis is generated on the basis of the compressed image thus taken.

### SUMMARY

However, according to the conventional arts, it is difficult to set appropriate values for arithmetic parameters used for reconstruction calculation of compressed sensing, and it is therefore difficult to achieve a balance between image quality of a reconstruction image and a calculation speed.

One non-limiting and exemplary embodiment provides an information processing method and an information processing apparatus that can set an appropriate value for one or more arithmetic parameters and effectively perform reconstruction calculation of compressed sensing.

In one general aspect, the techniques disclosed here feature an information processing method executed by a computer, the information processing method including acquiring a compressed image including pixels each having data including information on four or more wavelength bands; acquiring image quality adjustment information for adjusting image quality of four or more spectral images that are generated by executing reconstruction calculation based on the compressed image and correspond to the four or more wavelength bands, respectively; determining one or more values of one or more arithmetic parameters used in the reconstruction calculation on the basis of the image quality adjustment information; and generating the four or more spectral images by executing the reconstruction calculation on the compressed image by using the determined values of the arithmetic parameters.

According to the present disclosure, it is possible to set an appropriate value for one or more arithmetic parameters and effectively perform reconstruction calculation of compressed sensing.

It should be noted that general or specific embodiments may be implemented as a system, an apparatus, an integrated circuit, a computer program, a computer-readable storage medium, or any selective combination thereof. Examples of the computer-readable storage medium include non-volatile storage media such as a Compact Disc-Read Only memory (CD-ROM).

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a functional configuration diagram of an imaging system according to an embodiment;

FIG. 2 is a schematic view of an imaging device according to the embodiment;

FIG. 3A is a schematic view of a filter array according to the embodiment;

FIG. 3B illustrates an example of a transmission spectrum of a filter according to the embodiment;

FIG. 3C illustrates an example of a transmission spectrum of another filter according to the embodiment;

FIG. 3D illustrates an example of transmittance of a first wavelength band of the filter array according to the embodiment;

FIG. 3E illustrates an example of transmittance of a second wavelength band of the filter array according to the embodiment;

FIG. 4 is a flowchart of the information processing method according to the embodiment;

FIG. 5 illustrates an example of a graphical user interface (GUI) according to the embodiment;

FIG. 6 illustrates an example of a conversion table according to the embodiment;

FIG. 7 illustrates an example of a GUI according to Modification 1;

FIG. 8 illustrates an example of a GUI according to Modification 2;

FIG. 9 illustrates an example of a GUI according to Modification 2;

FIG. 10 illustrates an example of a GUI according to Modification 3;

FIG. 11 is a flowchart of a parameter determining process according to Modification 3;

FIG. 12 illustrates an example of a GUI according to Modification 4; and

FIG. 13 is a flowchart of an information processing method according to Modification 4.

### DETAILED DESCRIPTIONS

### Outline of Present Disclosure

An outline of the present disclosure is described before description of an embodiment.

An information processing method according to a first aspect of the present disclosure is an information processing method executed by a computer, the information processing method including acquiring a compressed image including pixels each having data including information on four or more wavelength bands; acquiring image quality adjustment information for adjusting image quality of four or more spectral images that are generated by executing reconstruction calculation based on the compressed image and correspond to the four or more wavelength bands, respectively; determining one or more values of one or more arithmetic parameters used in the reconstruction calculation on the basis of the image quality adjustment information; and generating the four or more spectral images by executing the reconstruction calculation on the compressed image by using the determined values of the arithmetic parameters.

According to this, the values of the arithmetic parameters are determined on the basis of the image quality adjustment information. That is, the values of the arithmetic parameters are determined when the image quality adjustment information is given. This makes it unnecessary to directly set values for the arithmetic parameters, thereby lowering difficulty of setting of the values of the arithmetic parameters. As a result, it is possible to appropriately set values for the arithmetic parameters and effectively perform reconstruction calculation of compressed sensing of a hyperspectral image.

An information processing method according to a second aspect of the present disclosure is the information processing method according to the first aspect and further includes displaying a graphical user interface for acquiring the image quality adjustment information, and the image quality adjustment information is acquired via the graphical user interface.

According to this, the image quality adjustment information is acquired via the graphical user interface. This allows a user to easily input the image quality adjustment information, thereby further lowering difficulty of setting of the values of the arithmetic parameters.

An information processing method according to a third aspect of the present disclosure is the information processing method according to the second aspect and further includes displaying the compressed image and the generated four or more spectral images.

According to this, the four or more spectral images generated on the basis of the image quality adjustment information are displayed. This allows a user to visually check a reconstruction result and to easily determine whether or not the values of the arithmetic parameters determined on the basis of the image quality adjustment information are appropriate.

An information processing method according to a fourth aspect of the present disclosure is the information processing method according to the third aspect and further includes displaying a period required for the reconstruction calculation.

According to this, the period required for the reconstruction calculation is displayed. This allows a user to visually check the reconstruction period and to easily determine whether or not the values of the arithmetic parameters determined on the basis of the image quality adjustment information are appropriate.

An information processing method according to a fifth aspect of the present disclosure is the information processing method according to any one of the first to fourth aspects, in which the image quality adjustment information includes a value of a first degree of priority that is a degree of priority of image quality of the four or more spectral images, a value of a second degree of priority that is a degree of priority of speed of the reconstruction calculation, or a combination of the value of the first degree of priority and the value of the second degree of priority.

According to this, the image quality adjustment information includes a degree of priority of image quality and/or a degree of priority of speed of reconstruction calculation. Therefore, information that can be intuitively understood by a user can be used as the image quality adjustment information. This can further lower difficulty of setting of the values of the arithmetic parameters, thereby making it possible to more effectively perform reconstruction calculation of compressed sensing.

An information processing method according to a sixth aspect of the present disclosure is the information processing method according to the fifth aspect, in which the arithmetic parameters include a first parameter that corresponds to a degree of influence of regularization in the reconstruction calculation.

According to this, the value of the first parameter corresponding to the degree of influence of regularization can be determined on the basis of the image quality adjustment information. The degree of influence of regularization in the reconstruction calculation influences image quality of a reconstruction image and a calculation speed. Therefore, by determining the value of the first parameter corresponding to the degree of influence of regularization on the basis of the image quality adjustment information, it is possible to achieve a balance between image quality of a reconstruction image and a calculation speed and more effectively perform reconstruction calculation of compressed sensing.

An information processing method according to a seventh aspect of the present disclosure is the information processing method according to the sixth aspect, in which a value of the first parameter is determined so that the degree of influence of the regularization becomes lower as the first degree of priority becomes higher or as the second degree of priority becomes lower.

According to this, in a case where priority is given to image quality or in a case where priority is not given to a speed of reconstruction calculation, the degree of influence of regularization can be lowered. In a case where the degree of influence of regularization is low, the image quality improves but the calculation speed decreases. Therefore, in a case where priority is given to image quality or in a case where priority is not given to a speed of reconstruction calculation, it is possible to ensure consistency between the image quality adjustment information and the image quality and calculation speed by lowering the degree of influence of regularization. This can realize user's intuitive operation.

An information processing method according to an eighth aspect of the present disclosure is the information processing method according to any one of the fifth to seventh aspects, in which the arithmetic parameters include a second parameter that corresponds to the number of iterations of iterative operation included in the reconstruction calculation.

According to this, the value of the second parameter that corresponds to the number of iterations of iterative operation can be determined on the basis of the image quality adjustment information. The number of iterations in the reconstruction calculation influences image quality of a reconstruction image and a calculation speed. Therefore, by determining the value of the second parameter that corresponds to the number of iterations on the basis of the image quality adjustment information, it is possible to achieve a balance between image quality of a reconstruction image and a calculation speed and to more effectively perform reconstruction calculation of compressed sensing.

An information processing method according to a ninth aspect of the present disclosure is the information processing method according to the eighth aspect, in which a value of the second parameter is determined so that the number of iterations becomes larger as the first degree of priority becomes higher or as the second degree of priority becomes lower.

According to this, in a case where priority is given to image quality or in a case where priority is not given to a speed of reconstruction calculation, the number of iterations of iterative operation can be increased. In a case where the number of iterations is large, the image quality improves but the calculation speed decreases. Therefore, in a case where priority is given to image quality or in a case where priority is not given to a speed of reconstruction calculation, it is possible to ensure consistency between the image quality adjustment information and the image quality and calculation speed by increasing the number of iterations. This can realize user's intuitive operation.

An information processing method according to a tenth aspect of the present disclosure is the information processing method according to any one of the first to ninth aspects, in which the image quality adjustment information includes at least one of information indicative of color reproducibility in the four or more spectral images or information indicative of a size of a structure of a subject in the four or more spectral images.

According to this, the image quality adjustment information includes information indicative of color reproducibility and/or a structure size. Therefore, information that can be intuitively understood by a user can be used as the image quality adjustment information. This can further lower difficulty of setting of the values of the arithmetic parameters, thereby making it possible to more effectively perform reconstruction calculation of compressed sensing.

An information processing method according to an eleventh aspect of the present disclosure is the information processing method according to any one of the first to tenth aspects, in which the arithmetic parameters include a first parameter that corresponds to a degree of influence of regularization in the reconstruction calculation, and a value of the first parameter is determined on the basis of an average luminance value of the compressed image and the image quality adjustment information.

According to this, the value of the first parameter that corresponds to the degree of influence of regularization is determined on the basis of the average luminance value of the compressed image. In a case where the average luminance value of the compressed image is large, influence of a residual term minimized in the reconstruction calculation on a sum of the residual term and a regularization term tends to increase. Therefore, it is possible to achieve a balance between the residual term and the regularization term by adjusting the degree of influence of regularization on the basis of the average luminance value of the compressed image.

An information processing apparatus according to a twelfth aspect of the present disclosure includes an image acquirer that acquires a compressed image including pixels each having data including information on four or more wavelength bands; an information acquirer that acquires image quality adjustment information for adjusting image quality of four or more spectral images that are generated by executing reconstruction calculation based on the compressed image and correspond to the four or more wavelength bands, respectively; a parameter determiner that determines one or more values of one or more arithmetic parameters used in the reconstruction calculation on the basis of the image quality adjustment information; and a reconstruction calculator that generates the four or more spectral images by executing the reconstruction calculation on the compressed image by using the determined values of the arithmetic parameters.

According to this, effects similar to those of the information processing method can be realized by the information processing apparatus.

An information processing method according to a thirteenth aspect of the present disclosure is an information processing method executed by a computer and includes acquiring a compressed image including pixels that are different in exposure period or amount of transmitted light, acquiring image quality adjustment information for adjusting image quality of a high dynamic range image that is generated by executing reconstruction calculation based on the compressed image and has a higher dynamic range than the compressed image, determining on or more values of one or more arithmetic parameters used in the reconstruction calculation on the basis of the image quality adjustment information, and generating the high dynamic range image by executing the reconstruction calculation on the compressed image by using the determined values of the arithmetic parameters.

According to this, the values of the arithmetic parameters are determined on the basis of the image quality adjustment information. That is, the values of the arithmetic parameters are determined when the image quality adjustment information is given. This makes it unnecessary to directly set values for the arithmetic parameters, thereby lowering difficulty of setting of the values of the arithmetic parameters. As a result, it is possible to appropriately set values for the arithmetic parameters and effectively perform reconstruction calculation of compressed sensing of a high dynamic range image.

An information processing method according to a fourteenth aspect of the present disclosure is an information processing method executed by a computer and includes acquiring a compressed image including pixels that are different in exposure pattern of coded exposure, acquiring image quality adjustment information for adjusting image quality of images (temporal super-resolution image) that are generated by executing reconstruction calculation based on the compressed image and correspond to different times, determining one or more values of one or more arithmetic parameters used in the reconstruction calculation on the basis of the image quality adjustment information, and generating the images by executing the reconstruction calculation on the compressed image by using the determined values of the arithmetic parameters.

According to this, the values of the arithmetic parameters are determined on the basis of the image quality adjustment information. That is, the values of the arithmetic parameters are determined when the image quality adjustment information is given. This makes it unnecessary to directly set values for the arithmetic parameters, thereby lowering difficulty of setting of the values of the arithmetic parameters. As a result, it is possible to appropriately set values for the arithmetic parameters and effectively perform reconstruction calculation of compressed sensing of a temporal super-resolution image.

An information processing method according to a fifteenth aspect of the present disclosure is an information processing method executed by a computer and includes acquiring a compressed image including pixels each having data including image information from viewpoints, acquiring image quality adjustment information for adjusting image quality of images (multi-view image) that are generated by executing reconstruction calculation based on the compressed image and correspond to different viewpoints, determining one or more values of one or more arithmetic parameters used in the reconstruction calculation on the basis of the image quality adjustment information, and generating the images by executing the reconstruction calculation on the compressed image by using the determined values of the arithmetic parameters.

According to this, the values of the arithmetic parameters are determined on the basis of the image quality adjustment information. That is, the values of the arithmetic parameters are determined when the image quality adjustment information is given. This makes it unnecessary to directly set values for the arithmetic parameters, thereby lowering difficulty of setting of the values of the arithmetic parameters. As a result, it is possible to appropriately set values for the arithmetic parameters and effectively perform reconstruction calculation of compressed sensing of a multi-view image.

### EMBODIMENT

An embodiment is specifically described below with reference to the drawings.

An embodiment described below is a general or specific example. Numerical values, shapes, materials, constituent elements, the way in which the constituent elements are disposed and connected, steps, the order of steps, and the like in the embodiment below are examples and do not limit the present disclosure.

Each drawing is a schematic view and is not necessarily strict illustration. Therefore, for example, scales and the like in the drawings do not necessarily match. In the drawings, substantially identical constituent elements are given identical reference signs, and repeated description thereof is sometimes omitted or simplified.

In the following description, terms indicating relationships between elements, such as “parallel” or “perpendicular”, terms indicating shapes of elements, such as “rectangular” or “circular”, and numerical ranges are not expressions limited to their strict meanings, but are expressions intended to encompass substantially equivalent ranges, for example, differences of several percent.

In the following description, all or a part of any of circuit, unit (part), device, or any of functional blocks in the block diagrams may be, for example, implemented as one or more of electronic circuits including, but not limited to, a semiconductor device, a semiconductor integrated circuit (IC) or a large scale integration (LSI). The LSI or IC can be integrated into one chip, or also can be a combination of plural chips. For example, functional blocks other than a memory may be integrated into one chip. The name used here is LSI or IC, but it may also be called system LSI, very large scale integration (VLSI), or ultra large scale integration (ULSI) depending on the degree of integration. A Field Programmable Gate Array (FPGA) that can be programmed after manufacturing an LSI or a reconfigurable logic device (RLD) that allows reconfiguration of the connection or setup of circuit cells inside the LSI can be used for the same purpose.

Further, all or a part of any of circuit, unit (part), device, or any of functional blocks in the block diagrams may be implemented by executing a software program. In such a case, the software program is recorded on one or more non-transitory recording media such as a ROM, an optical disk or a hard disk drive, and when the software program is executed by a processor, the software program causes the processor together with peripheral devices to execute the functions specified in the software processor. A system or apparatus may include such one or more non-transitory recording media on which the software program is recorded and a processor together with necessary hardware devices such as a memory and an interface.

### Functional Configuration of Imaging System 1000

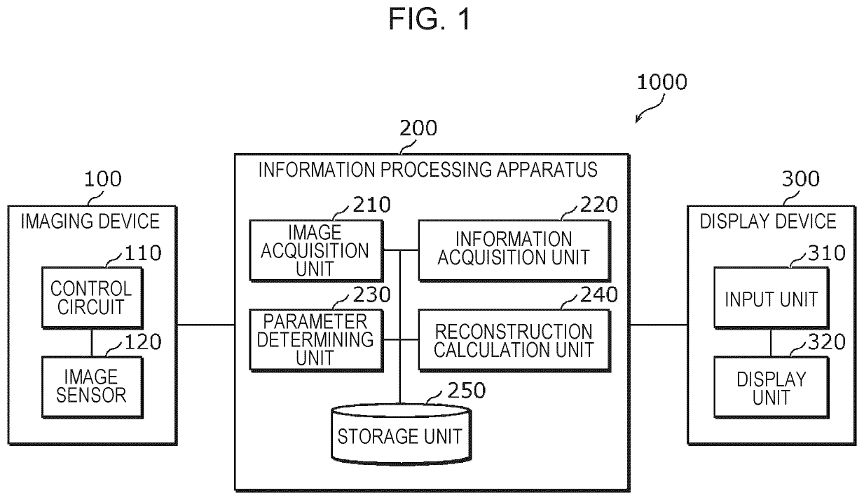

First, a functional configuration of an imaging system 1000 according to the present embodiment is specifically described with reference to FIG. 1. FIG. 1 is a functional configuration diagram of the imaging system 1000 according to the present embodiment. Note that FIG. 1 illustrates an exemplary functional configuration of the imaging system 1000, and the functional configuration of the imaging system 1000 is not limited to that illustrated in FIG. 1.

As illustrated in FIG. 1, the imaging system 1000 includes an imaging device 100, an information processing apparatus 200, and a display device 300. The imaging device 100, the information processing apparatus 200, and the display device 300 included in the imaging system 1000 are described in detail below in order.

The imaging device 100 has a similar configuration to that of the imaging device disclosed in Patent Literature 1, and can take a compressed image including pixels. Each of the pixels included in the compressed image includes information on four or more wavelength bands. The imaging device 100 includes a control circuit 110 and an image sensor 120.

The control circuit 110 can control the image sensor 120 to generate a compressed image.

The image sensor 120 is a monochromatic photodetector including photodetection elements that are arranged in a matrix. The image sensor 120 can be, for example, a charge-coupled device (CCD) image sensor, a complementary metal oxide semiconductor (CMOS) image sensor, an infrared array image sensor, a terahertz array image sensor, or a millimeter-wave array image sensor. Note that the image sensor 120 need not be a monochromatic photodetector and may be a color-type photodetector. A wavelength range that can be detected by the image sensor 120 is not limited in particular, and may be, for example, visible light, ultraviolet light, infrared light, a terahertz wave, or any combination thereof.

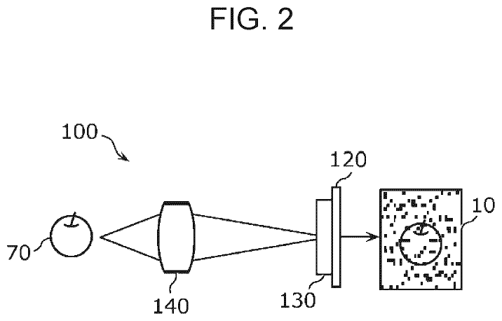

The imaging device 100 further includes a filter array 130 and an optical system 140 (not illustrated in FIG. 1). A configuration of the imaging device 100 including the filter array 130 and the optical system 140 will be described later with reference to FIG. 2.

The information processing apparatus 200 is communicably connected to the imaging device 100 and the display device 300 via wired and/or wireless connection. The information processing apparatus 200 includes an image acquisition unit 210, an information acquisition unit 220, a parameter determination unit 230, a reconstruction calculation unit 240, and a storage unit 250.

The image acquisition unit 210 can acquire a compressed image from the imaging device 100 and store the acquired compressed image in the storage unit 250. Note that the image acquisition unit 210 need not directly acquire a compressed image from the imaging device 100 and may acquire a compressed image via another device or the like.

The information acquisition unit 220 can acquire image quality adjustment information from the display device 300. Note that the information acquisition unit 220 need not directly acquire image quality adjustment information from the display device 300 and may acquire image quality adjustment information via another device or the like.

The parameter determination unit 230 can determine a value of an arithmetic parameter used in reconstruction calculation on the basis of the image quality adjustment information. That is, the parameter determination unit 230 can determine one or more values that correspond to one or more arithmetic parameters used in the reconstruction calculation on a one-to-one basis on the basis of the image quality adjustment information. The image quality adjustment information means information for adjusting image quality of four or more spectral images obtained by the reconstruction calculation. For example, the image quality adjustment information may include a value of a first degree of priority that is a degree of priority of image quality of the four or more spectral images, a value of a second degree of priority that is a degree of priority of a speed of generation of the four or more spectral images from the compressed image, or a combination of the value of the first degree of priority and the value of the second degree of priority. The arithmetic parameters may be a first parameter (a weight coefficient τ, which will be described later) corresponding to a degree of influence of regularization in the reconstruction calculation and/or a second parameter corresponding to the number of iterations of iterative operation included in the reconstruction calculation.

The reconstruction calculation unit 240 can generate four or more spectral images by executing the reconstruction calculation on the compressed image by using the values of the arithmetic parameters determined by the parameter determination unit 230.

Note that the reconstruction calculation performed in the present embodiment may be identical to the reconstruction calculation described in Patent Literature 1 or 2. Specifically, four or more spectral images may be generated on the basis of the following formula (1).

$$g = Hf = H [ \begin{matrix}{f}_{1} \\ {f}_{2} \\ ⋮ \\ {f}_{w}\end{matrix} ] \qquad ( 1 )$$

In the formula (1), g represents data indicative of the compressed image and is expressed, for example, as a one-dimensional array (i.e., a vector). In a case where the compressed image is an image having n×m pixels, the data g is expressed as a one-dimensional array having n×m elements. f represents data indicative of w spectral images that correspond to w wavelength bands on a one-to-one basis and is expressed, for example, as a one-dimensional array. f1 represents data of a spectral image corresponding to a wavelength band W₁, f2 is data of a spectral image corresponding to a wavelength band W₂, . . . , and fw represents data of a spectral image corresponding to a wavelength band W_{w}. f1, f2, . . . , and fw are each expressed, for example, as a one-dimensional array. In a case where each spectral image is an image having n×m pixels, f1, f2, . . . , and fw are each expressed as a one-dimensional array having n×m elements, and the data f is expressed as a one-dimensional array having n×m×w elements. H is a matrix of n×m rows and n×m×w columns, and is sometimes referred to as a system matrix. H may be determined on the basis of a transmission spectrum of the wavelength band W₁ of the filter array 130, a transmission spectrum of the wavelength band W₂ of the filter array 130, . . . , and a transmission spectrum of the wavelength band W_{W} of the filter array 130. The data f that satisfies such a formula (1) can be estimated by using a compressed sensing method, and can be estimated, specifically, by a formula (2).

$$f = {arg min}_{f} \{ {‖ g - Hf ‖}_{{I}_{2}} + τ Φ ( f ) \} \qquad ( 2 )$$

The formula (2) means that f that minimizes a sum of the first term and the second term in the braces is found. The data f as a final solution can be calculated by convergence of solutions by recursive iterative operation.

The first term in the braces in the formula (2) represents a sum of squares of a difference between the data g and Hf obtained by system conversion of the data f in the estimation process by the matrix H, that is, a residual term. Although a sum of squares is used in this formula, a sum of absolute values, a square-root of sum of squares, or the like may be used instead of the sum of squares. The sum of squares of the difference between Hf and the data g is (g₁−r₁)×(g₁−r₁)+ . . . +(g_{n×m}−r_{n×m})λ(g_{n×m}−r_{n×m}). Note that g=(g₁ . . . g_{n×m})^{T} and Hf=(r₁ . . . r_{n×m})^{T}.

The second term in the braces in the formula (2) is sometimes called a regularization term or a stabilization term. ((f) represents a constraint condition in regularization of f and is a function reflecting sparse information of the data f. This function brings an effect of smoothing or stabilizing the data f. Φ(f) can be, for example, expressed by discrete cosine transform (DCT), wavelet transform, Fourier transform, total variation (TV), any combination thereof, or the like. τ is a weight coefficient of the regularization term and corresponds to a degree of influence of regularization in the reconstruction calculation. As the value of T increases, the degree of influence of the regularization becomes greater, the amount of redundant data removed increases, and solution convergence in the iterative operation becomes stronger. Conversely, as the value of T decreases, the degree of influence of the regularization becomes smaller, the amount of redundant data removed decreases, and solution convergence in the iterative operation becomes weaker.

In the formula (2), T can be used as the first parameter. Furthermore, the number of iterations of the recursive iterative operation in the formula (2) can be used as the second parameter. The reconstruction calculation unit 240 can generate four or more spectral images by executing the reconstruction calculation of the formula (2) by using the value of the first parameter and the value of the second parameter.

The storage unit 250 can store therein the compressed image, the four or more spectral images (reconstruction image), and/or the like. The storage unit 250 can be, for example, a hard disk drive, a solid state drive, or the like.

The display device 300 is a user interface, and includes an input unit 310 and a display unit 320. The display device 300 can be, for example, a tablet computer, a smartphone, a desktop computer, or the like.

The input unit 310 can receive input of the image quality adjustment information from a user. The input unit 310 can be, for example, a touch screen, a touch pad, a mouse, a keyboard, any combination thereof, or the like.

The display unit 320 can display a graphical user interface (GUI) for acquiring the image quality adjustment information. The display unit 320 can be, for example, a liquid crystal display (LCD), an organic light-emitting diode (OLED) display, or the like.

Note that FIG. 1 illustrates an exemplary functional configuration of the imaging system 1000, and the functional configuration of the imaging system 1000 is not limited to that illustrated in FIG. 1. For example, a part or all of the imaging device 100 may be included in the information processing apparatus 200. For example, a part or all of the display device 300 may be included in the information processing apparatus 200. For example, the information processing apparatus 200 may be divided into apparatuses or may be, for example, realized by a cloud server.

### Configuration of Imaging Device 100

Next, a configuration of the imaging device 100 is described with reference to FIG. 2. FIG. 2 is a schematic view of the imaging device 100 according to the embodiment.

The imaging device 100 has a similar configuration to the imaging devices disclosed in Patent Literatures 1 and 2. Specifically, the imaging device 100 includes the control circuit 110, the image sensor 120, the filter array 130, and the optical system 140. In FIG. 2, illustration of the control circuit 110 is omitted.

The filter array 130 is disposed on an optical path of light entering from a target 70, which is a subject, and is disposed between the optical system 140 and the image sensor 120 in FIG. 2. The filter array 130 functions as an encoding element of Patent Literature 1. The filter array 130 may be integral with the image sensor 120. Note that the position of the filter array 130 is not limited to that illustrated in FIG. 2. For example, the filter array 130 may be disposed away from the image sensor 120 between the optical system 140 and the image sensor 120. For example, the filter array 130 may be disposed between the target 70 and the optical system 140. For example, the filter array 130 may be disposed in the optical system 140.

The optical system 140 is disposed on an optical path of light entering from the target 70 and is disposed between the target 70 and the filter array 130 in FIG. 2. The optical system 140 includes at least one lens and can form an image of the target 70 on an imaging surface of the image sensor 120 through the filter array 130. Note that the configuration and position of the optical system 140 are not limited to those in FIG. 2. For example, the optical system 140 may be disposed between the filter array 130 and the image sensor 120. For example, the optical system 140 may include lenses arranged on the optical path. In this case, the filter array 130 may be disposed between adjacent lenses among the lenses.

### Configuration of Filter Array 130

The filter array 130 includes filters. The number of filters may be n×m. The n×m filters include a filter₁₁, . . . , and a filterₙₘ. All of a transmission spectrum S₁₁ of the filter ii in the wavelength bands W₁ to W_{W}, . . . , and a transmission spectrum Sₙₘ of the filterₙₘ in the wavelength bands W₁ to W_{W} may be different or some of the transmission spectrum S₁₁, . . . , and the transmission spectrum Sₙₘ may be identical.

All of transmittance S_{11W1} of the filter ii in the wavelength band W₁, . . . transmittance S_{11Ww} of the filter ii in the wavelength band W_{W}, . . . , transmittance S_{nmW1} of the filterₙₘ in the wavelength band W₁, . . . , and transmittance S_{nmW1} of the filterₙₘ in the wavelength band W_{W} may be different or some of the transmittance S_{11W1}, . . . , transmittance S_{11Ww}, . . . , transmittance S_{nmW1}, . . . , and transmittance S_{nmWw} may be identical. w may be an integer of 4 or more. Note that in the present disclosure, the transmittance may mean light transmittance.

Transmittance of a filter β in a wavelength band W_{α} may be the following formula (3).

$${\int }_{W α min}^{W α max} h ( λ ) d λ \qquad ( 3 )$$

Wαmin is a minimum wavelength value of a wavelength band W_{α}, Wαmax is a maximum wavelength value of the wavelength band W_{α}, h (λ) is a function indicative of a transmission spectrum, and λ is a wavelength.

Note that the transmittance of the filter β in the wavelength band W_{α} is not limited to the formula (3). For example, the transmittance of the filter β in the wavelength band W_{α} may be transmittance obtained by dividing the formula (3) by (Wαmax−Wαmin). Alternatively, for example, the transmittance of the filter β in the wavelength band W_{α} may be transmittance h (λ_{α0}) at a frequency λ_{α0} representing the wavelength band W_{α}. λ_{α0} need just be a frequency that satisfies Wαmin≤λ_{α0}≤Wαmax and may be, for example, a central frequency ((Wαmax−Wαmin)/2) of the wavelength band W_{α}.

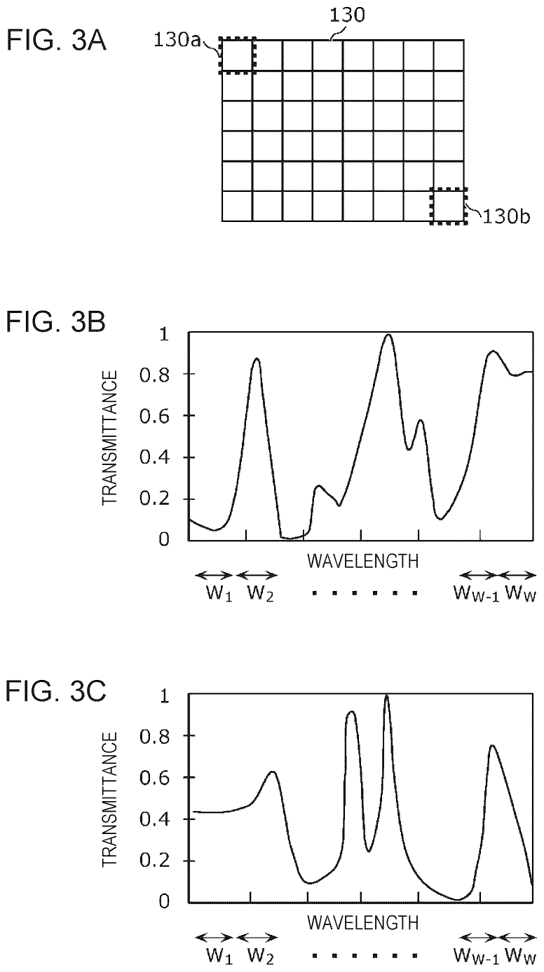

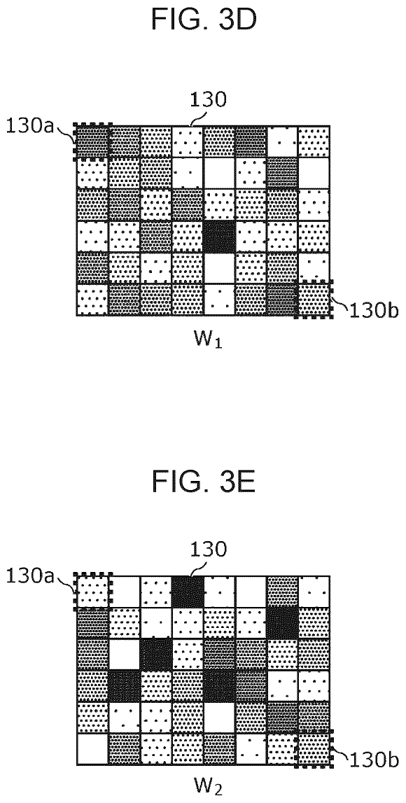

The configuration of the filter array 130 is described with reference to FIGS. 3A to 3E. FIG. 3A is a schematic view of the filter array 130 according to the embodiment. The filter array 130 includes a filter 130a and a filter 130b. FIG. 3B illustrates an example of a transmission spectrum of the filter 130a. FIG. 3C illustrates an example of a transmission spectrum of the filter 130b.

FIG. 3D illustrates an example of transmittance of the filter array 130 in the wavelength band W₁ according to the embodiment. FIG. 3E illustrates an example of transmittance of the filter array 130 in the wavelength band W₂ according to the embodiment. In FIGS. 3D and 3E, a density in each region represents transmittance of a filter, and a paler region indicates higher transmittance, and a deeper region indicates lower transmittance.

The filter array 130 includes filters arranged in a matrix. In the example illustrated in FIG. 3A, the filter array 130 includes 48 filters arranged in six rows and eight columns. The filter 130a is an upper left filter among the 48 filters, and the filter 130b is a lower right filter among the 48 filters. Note that the number of filters included in the filter array 130 is not limited to 48. For example, the number of filters included in the filter array 130 may be similar to the number of pixels of the image sensor 120 and may be determined according to application, for example, in a range from several tens to several tens of millions.

The filters included in the filter array 130 are different from each other in wavelength dependence of transmittance. For example, in the filter 130a, the transmittance in the wavelength band W₁ is far lower than the transmittance in the wavelength band W₂. On the other hand, in the filter 130b, the transmittance in the wavelength band W₁ is almost identical to the transmittance in the wavelength band W₂. That is, the wavelength dependence of transmittance of the filter 130a is different from the wavelength dependence of transmittance of the filter 130b. Note that only transmittance in the two wavelength bands W₁ and W₂ among the four or more wavelength bands is illustrated and described, and illustration and description of transmittance in the other wavelength bands included in the four or more wavelength bands are omitted.

### Information Processing Method

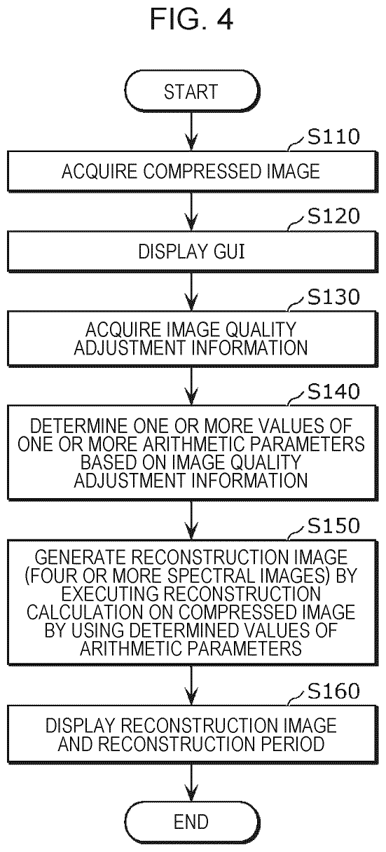

Next, an information processing method in the imaging system 1000 configured as above is described with reference to FIGS. 4 to 6. FIG. 4 is a flowchart of the information processing method according to the embodiment.

Steps S₁₁₀ to S₁₃₀

First, the image acquisition unit 210 of the information processing apparatus 200 acquires a compressed image from the imaging device 100 (S110). The display unit 320 of the display device 300 displays a GUI for acquiring the image quality adjustment information (S120). The input unit 310 of the display device 300 receives input of the image quality adjustment information via the GUI, and the information acquisition unit 220 of the information processing apparatus 200 acquires the image quality adjustment information from the display device 300 (S130).

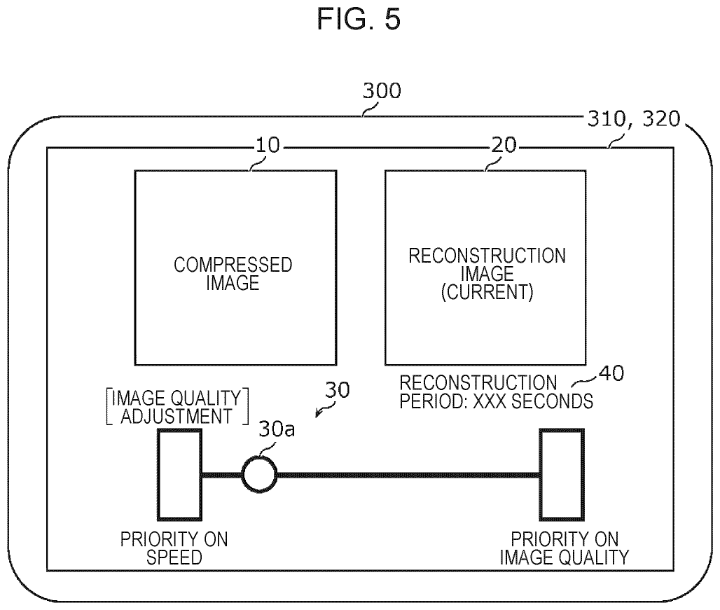

FIG. 5 illustrates an example of the GUI according to the embodiment. In FIG. 5, labels “COMPRESSED IMAGE” and “RECONSTRUCTION IMAGE (CURRENT)” represent regions where an image is displayed and need not be displayed on the actual GUI.

For example, the display unit 320 displays the GUI illustrated in FIG. 5 in step S120, and the input unit 310 receives input of image quality adjustment information via a slider 30 in step S130. The compressed image acquired in step S110 is displayed as a compressed image 10. The slider 30 is a GUI component for setting image quality adjustment information and sets image quality adjustment information corresponding to a horizontal position of an indicator 30a. In FIG. 5, the indicator 30a can set, as the image quality adjustment information, a value for a degree of priority (first degree of priority) of image quality of four or more spectral images (i.e., hyperspectral image) and for a degree of priority (second degree of priority) of a speed of reconstruction calculation. For example, in a case where the indicator 30a is located at a left end, the slider 30 sets 0% as the first degree of priority and sets 100% as the second degree of priority. On the other hand, in a case where the indicator 30a is located at a right end, the slider 30 sets 100% as the first degree of priority and sets 0% as the second degree of priority. For example, in a case where the indicator 30a is located at a center, the slider 30 sets 50% as the first degree of priority and sets 50% as the second degree of priority.

Note that although the value of the first degree of priority becomes larger as the first degree of priority becomes higher in the present embodiment, the value of the first degree of priority may become smaller as the first degree of priority becomes higher. Similarly, although the value of the second degree of priority becomes larger as the second degree of priority becomes higher, the value of the second degree of priority may become smaller as the second degree of priority becomes higher. The value of the second degree of priority depends on the value of the first degree of priority, and conversely the value of the first degree of priority depends on the value of the second degree of priority. Therefore, not both of the value of the first degree of priority and the value of the second degree of priority need be acquired, and only the value of the first degree of priority or only the value of the second degree of priority may be acquired.

FIG. 5 illustrates an exemplary configuration of the GUI, and the configuration of the GUI is not limited to that illustrated in FIG. 5. For example, another GUI component (e.g., a button and/or a text box) may be used instead of the slider 30. The compressed image 10, the current reconstruction image 20, the current reconstruction period 40, or any combination thereof need not necessarily be displayed.

### Step S140

The parameter determination unit 230 of the information processing apparatus 200 determines values of arithmetic parameters used in reconstruction calculation on the basis of the image quality adjustment information (S140).

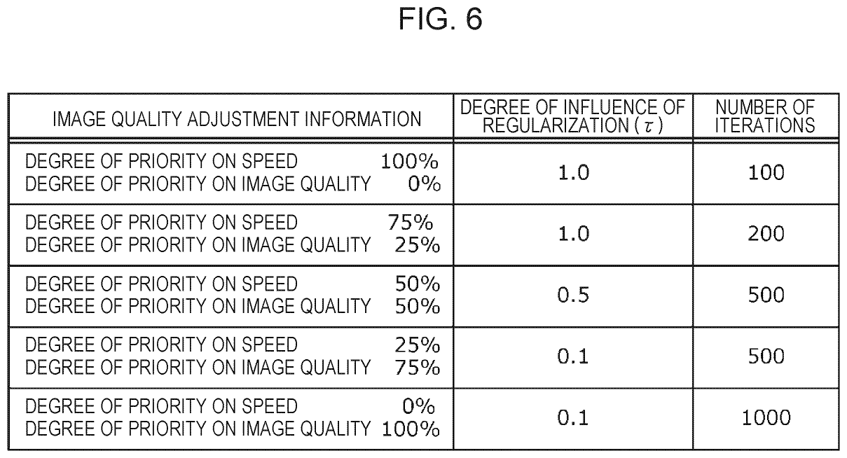

FIG. 6 illustrates an example of a conversion table according to the embodiment. For example, the parameter determination unit 230 determines a value of a degree of influence of regularization and a value of the number of iterations by referring to the conversion table illustrated in FIG. 6.

In the conversion table of FIG. 6, the value of the degree of influence of regularization is set so that the degree of influence of regularization becomes lower as the degree of priority of image quality (first degree of priority) becomes higher. For example, the value of the degree of influence of regularization “0.1” is set for the highest value of the degree of priority of image quality “100%”, and the value of the degree of influence of regularization “1.0” is set for the lowest value of the degree of priority of image quality “0%”. The parameter determination unit 230 can thus determine the value of the first parameter corresponding to the degree of influence of regularization so that the degree of influence of regularization becomes lower as the degree of priority of image quality becomes higher.

In the conversion table of FIG. 6, the value of the degree of influence of regularization is set so that the degree of influence of regularization becomes lower as the degree of priority of speed (second degree of priority) becomes lower. For example, the value of the degree of influence of regularization “0.1” is set for the lowest value of the degree of priority of speed, and the value of the degree of influence of regularization “1.0” is set for the highest value of the degree of priority of speed “100%”. The parameter determination unit 230 can thus determine the value of the first parameter corresponding to the degree of influence of regularization so that the degree of influence of regularization becomes lower as the degree of priority of speed becomes lower.

In the conversion table of FIG. 6, the value of the number of iterations is set so that the number of iterations becomes larger as the degree of priority of image quality becomes higher. For example, the value of the number of iterations “1000” is set for the highest value of the degree of priority of image quality “100%”, and the value of the number of iterations “100” is set for the lowest value of the degree of priority of image quality “0%”. The parameter determination unit 230 can thus determine the value of the second parameter corresponding to the number of iterations so that the number of iterations of the iterative operation becomes larger as the degree of priority of image quality becomes higher.

In the conversion table of FIG. 6, the value of the number of iterations is set so that the number of iterations becomes larger as the degree of priority of speed becomes lower. For example, the value of the number of iterations “1000” is set for the lowest value of the degree of priority of speed “0%”, and the value of the number of iterations “100” is set for the highest value of the degree of priority of speed “100%”. The parameter determination unit 230 can thus determine the value of the second parameter corresponding to the number of iterations so that the number of iterations of the iterative operation becomes larger as the degree of priority of speed becomes lower.

Note that the conversion table need not necessarily be used to determine the parameters. For example, a value of T as the first parameter may be determined on the basis of a degree of priority of image quality P by using the following formula (4).

$$τ = 1. - 0.9 P / 100 \qquad ( 4 )$$

Since the values of the arithmetic parameters are determined on the basis of the image quality adjustment information as described above, it is unnecessary to directly set values for the arithmetic parameters, and it is therefore easy to set the values of the arithmetic parameters.

### Step S150

The reconstruction calculation unit 240 of the information processing apparatus 200 generates four or more spectral images by executing reconstruction calculation on the compressed image by using the determined values of the arithmetic parameters (S150). Specifically, the reconstruction calculation unit 240 estimates the data f by applying the value of the first parameter (T) and the value of the second parameter (number of iterations) determined in step S140 to the formula (2).

### Step S160

The display unit 320 of the display device 300 displays a reconstruction image and a reconstruction period (S160). For example, a current reconstruction image 20 and a current reconstruction period 40 are displayed, as illustrated in FIG. 5. The displayed current reconstruction image 20 and current reconstruction period 40 correspond to a current horizontal position of the indicator 30a. That is, a superimposed image of four or more spectral images generated on the basis of the current image quality adjustment information is displayed as the current reconstruction image 20, and a period required for reconstruction calculation of these four or more spectral images is displayed as the current reconstruction period 40. Note that the four or more spectral images may be displayed instead of the superimposed image or in addition to the superimposed image.

As described above, according to the GUI according to the present modification, the user can recognize the current reconstruction image 20 and the current reconstruction period 40, and can easily set the image quality adjustment information. For example, in a case where image quality of the current reconstruction image 20 is poor, the user can reset the degree of priority of image quality to a higher level. For example, in a case where the current reconstruction period 40 is long, the user can reset the degree of priority of speed to a higher level.

Note that the flowchart of FIG. 5 is an example, and steps, the order of steps, and the like are not limited to those in FIG. 5. For example, step S120 and S160 are optional steps, and need not necessarily be included in the information processing method according to the present disclosure.

### Modification 1

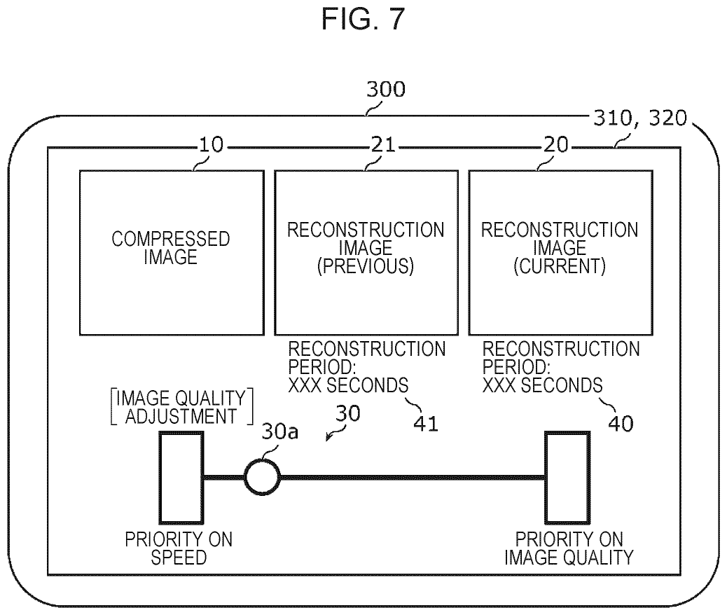

Next, Modification 1 of the embodiment is described. The present modification is mainly different in GUI from the above embodiment. The following mainly describes differences regarding a GUI according to the present modification from the above embodiment with reference to FIG. 7.

FIG. 7 illustrates an example of the GUI according to Modification 1. In FIG. 7, the labels “COMPRESSED IMAGE”, “RECONSTRUCTION IMAGE (CURRENT)”, and “RECONSTRUCTION IMAGE (PREVIOUS)” represent regions where an image is displayed, and need not be displayed on the actual GUI.

On the GUI of FIG. 7, a previous reconstruction image 21 and a previous reconstruction period 41 are displayed additionally. The displayed previous reconstruction image 21 and previous reconstruction period 41 correspond to a previous horizontal position of the indicator 30a. That is, a hyperspectral image obtained by superimposing four or more spectral images generated on the basis of previous image quality adjustment information is displayed as the previous reconstruction image 21, and a period required for reconstruction calculation of these four or more spectral images is displayed as the previous reconstruction period 41.

This allows a user to compare the current reconstruction image 20 and the current reconstruction period 40 with the previous reconstruction image 21 and the previous reconstruction period 41 and to easily set the image quality adjustment information. For example, in a case where the previous reconstruction image 21 and the previous reconstruction period 41 are better than the current reconstruction image 20 and the current reconstruction period 40, the user can set the previous value of the degree of priority of image quality and the previous value of the degree of priority of speed as the degree of priority of image quality and the degree of priority of speed. As a result, reconstruction calculation of compressed sensing can be more effectively performed.

### Modification 2

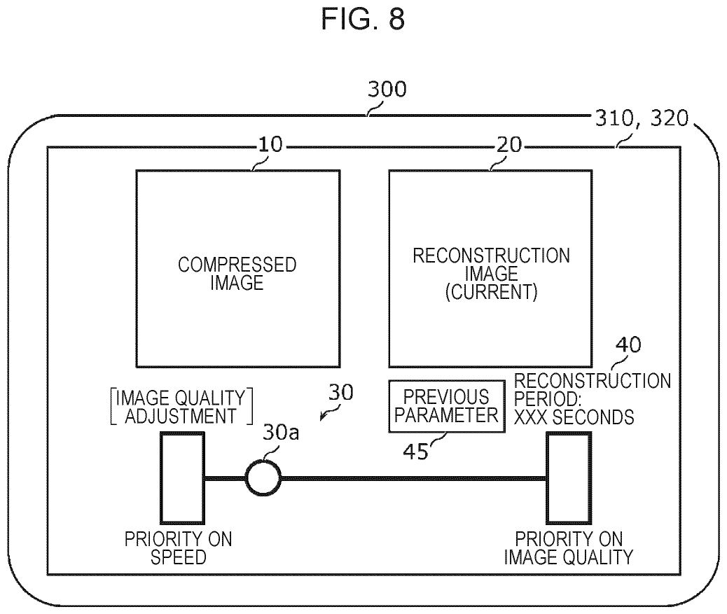

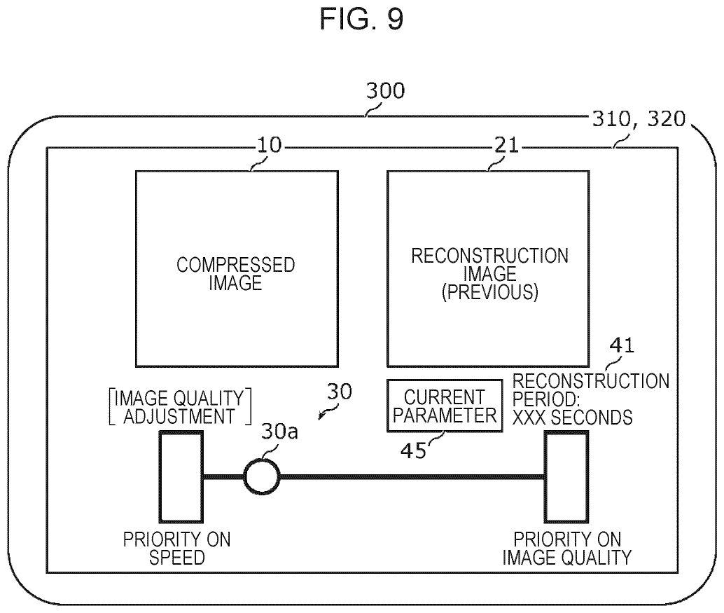

Next, Modification 2 of the embodiment is described. The present modification is mainly different in GUI from the above embodiment. The following mainly describes differences regarding a GUI according to the present modification from the above embodiment with reference to FIGS. 8 and 9.

FIGS. 8 and 9 illustrate an example of the GUI according to Modification 2. In FIGS. 8 and 9, the labels “COMPRESSED IMAGE”, “RECONSTRUCTION IMAGE (CURRENT)”, and “RECONSTRUCTION IMAGE (PREVIOUS)” represent regions where an image is displayed, and need not be displayed on the actual GUI.

On the GUI of FIG. 8, a button 45 is displayed additionally. The button 45 is a button for switching between a result of current reconstruction calculation and a result of previous reconstruction calculation. The result of the current reconstruction calculation means a result of reconstruction calculation performed on the basis of image quality adjustment information corresponding to a current horizontal position of the indicator 30a, and the result of the previous reconstruction calculation means a result of reconstruction calculation performed on the basis of image quality adjustment information corresponding to a previous horizontal position of the indicator 30a.

Specifically, the result of the current reconstruction calculation is switched to the result of the previous reconstruction calculation by pressing the button 45 given a label “PREVIOUS PARAMETER” illustrated in FIG. 8. As a result, as illustrated in FIG. 9, the current reconstruction image 20 and the current reconstruction period 40 are changed to the previous reconstruction image 21 and the previous reconstruction period 41, and the label of the button 45 is changed to “CURRENT PARAMETER”. Furthermore, the result of the previous reconstruction calculation is switched to the result of the current reconstruction calculation by pressing the button 45 given the label “CURRENT PARAMETER” illustrated in FIG. 9. As a result, as illustrated in FIG. 8, the previous reconstruction image 21 and the previous reconstruction period 41 are changed to the current reconstruction image 20 and the current reconstruction period 40, and the label of the button 45 is changed to “PREVIOUS PARAMETER”.

As described above, according to the GUI according to the present modification, the user can switch whether to display the current reconstruction image 20 and the current reconstruction period 40 or display the previous reconstruction image 21 and the previous reconstruction period 41. This can make a size of each image larger than that in FIG. 7, thereby improving user's visibility.

### Modification 3

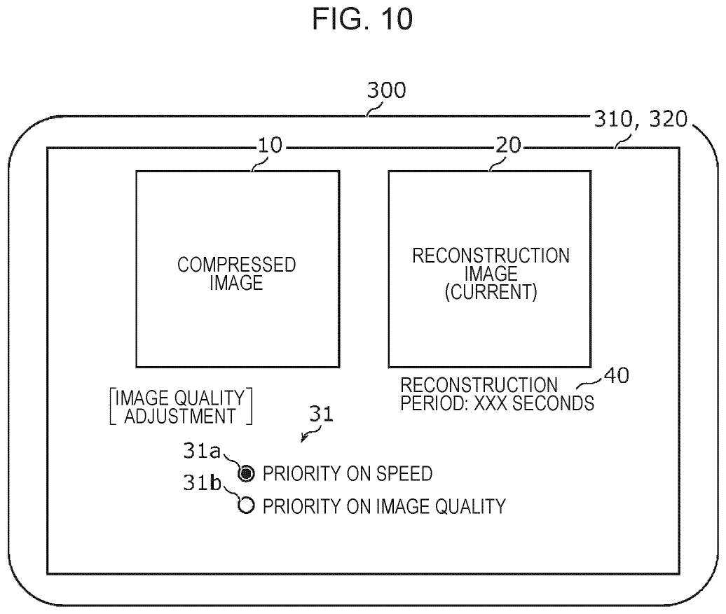

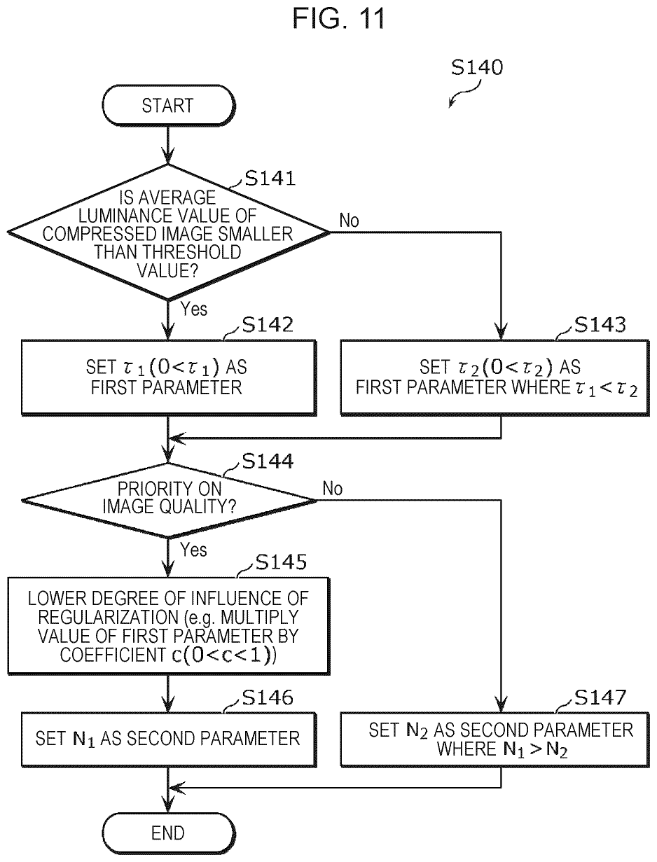

Next, Modification 3 of the embodiment is described. The present modification is mainly different in GUI from the above embodiment. The following mainly describes differences regarding a GUI and related processing according to the present modification from the above embodiment with reference to FIGS. 10 and 11.

FIG. 10 illustrates an example of the GUI according to the present modification. In FIG. 10, the labels “COMPRESSED IMAGE” and “RECONSTRUCTION IMAGE (CURRENT)” represent regions where an image is displayed, and need not be displayed on the actual GUI.

On the GUI of FIG. 10, a radio button 31 is displayed instead of the slider 30. The radio button 31 is a GUI component that allows a user to select one of a speed priority option 31a and an image quality priority option 31b that are mutually exclusive. The user can select either priority on speed or priority on image quality via the radio button 31.

A parameter determining process (step S140 in FIG. 4) performed in a case where either priority on speed or priority on image quality is selected on such a GUI is described with reference to FIG. 11. FIG. 11 is a flowchart of the parameter determining process (step S140 in FIG. 4) according to the present modification.

First, the parameter determination unit 230 determines whether or not an average luminance value of a compressed image is smaller than a threshold value (S141). That is, the parameter determination unit 230 calculates an average of luminance values of pixels included in the compressed image and determines whether or not the calculated average is smaller than the threshold value. A value predetermined empirically and/or experimentally can be used as the threshold value.

In a case where the average luminance value of the compressed image is smaller than the threshold value (Yes in S141), the parameter determination unit 230 sets Ti (0<Ti) as the first parameter (the weight coefficient T of the regularization term) corresponding to the degree of influence of regularization in reconstruction calculation (S142). On the other hand, in a case where the average luminance value of the compressed image is not smaller than the threshold value (No in S141), the parameter determination unit 230 sets τ₂ (0<τ₂) as the first parameter (S143). Here, τ₁ and τ₂ satisfy τ₁<τ₂. That is, the parameter determination unit 230 sets an initial value for the first parameter so that the degree of influence of regularization decreases in a case where the average luminance value of the compressed image is low.

The parameter determination unit 230 determines whether or not the image quality adjustment information acquired via the GUI indicates priority on image quality (S144). Specifically, the parameter determination unit 230 determines whether or not the image quality priority option 31b has been selected via the radio button 31 of FIG. 10.

In a case where the image quality adjustment information indicates priority on image quality, that is, in a case where the image quality priority option 31b has been selected (Yes in S144), the parameter determination unit 230 updates the value of the first parameter so that the degree of influence of regularization decreases (S145). For example, the parameter determination unit 230 updates the value of the first parameter by multiplying the first parameter set in step S142 or S143 by a coefficient c (0<c<1). That is, the parameter determination unit 230 updates the value of the first parameter so that the degree of influence of regularization decreases in a case where the degree of priority of image quality is high and the degree of priority of speed is low. Furthermore, the parameter determination unit 230 sets N₁ as the second parameter (the number of iterations) (S146).

On the other hand, in a case where the image quality adjustment information does not indicate priority on image quality, that is, in a case where the speed priority option 31a has been selected (No in S144), the parameter determination unit 230 sets N₂ as the second parameter (the number of iterations) (S147). Here, N₁ and N₂ satisfy N₁>N₂. That is, the parameter determination unit 230 sets the value of the second parameter so that the number of iterations decreases in a case where the degree of priority of image quality is low and the degree of priority of speed is high.

Note that multiplying the value of the first parameter by the coefficient c in step S145 is an example, and the process of updating the value of the first parameter in step S145 is not limited to this. For example, the parameter determination unit 230 may subtract a constant a (a>0) from the value of the first parameter. Alternatively for example, the parameter determination unit 230 may update the value of the first parameter by performing both of the multiplication (the coefficient c) and the subtraction (the constant a).

As described above, according to the GUI according to the present modification, the values of the arithmetic parameters are determined by selecting priority on speed or priority on image quality, and it is therefore easier to set the values of the arithmetic parameters. As a result, reconstruction calculation of compressed sensing can be more effectively performed.

### Modification 4

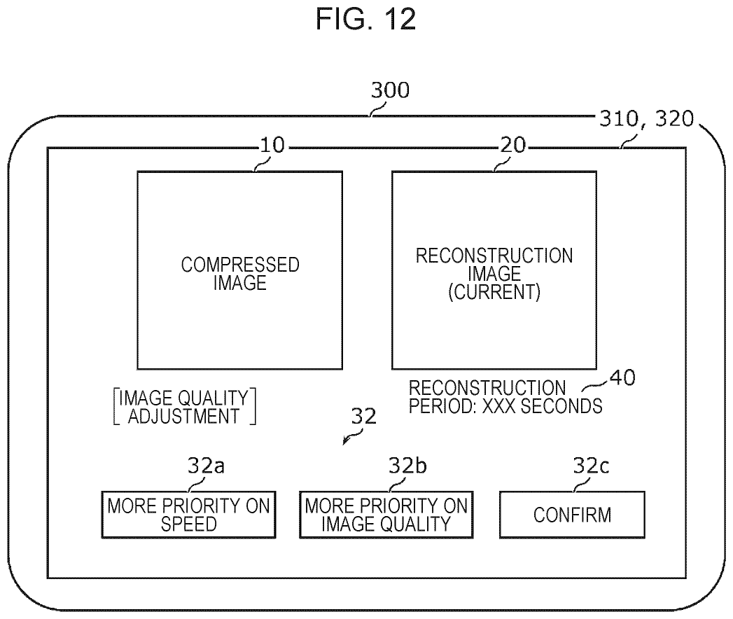

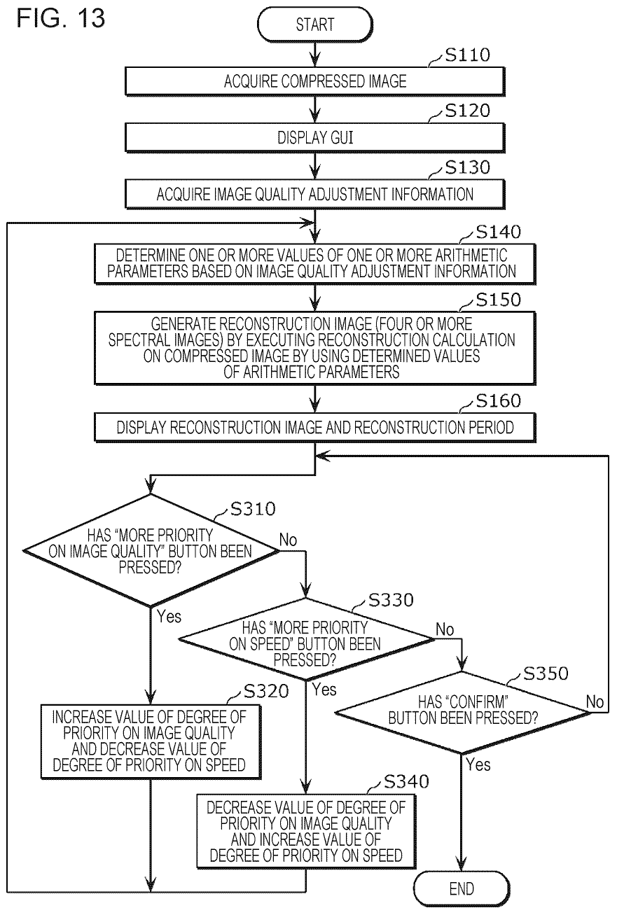

Next, Modification 4 of the embodiment is described. The present modification is mainly different in GUI from the above embodiment. The following mainly describes differences regarding a GUI and related processing according to the present modification from the above embodiment with reference to FIGS. 12 and 13.

FIG. 12 illustrates an example of the GUI according to the present modification. In FIG. 12, the labels “COMPRESSED IMAGE” and “RECONSTRUCTION IMAGE (CURRENT)” represent regions where an image is displayed, and need not be displayed on the actual GUI.

On the GUI of FIG. 12, a button set 32 including three buttons 32a to 32c is displayed instead of the slider 30. The button 32a is a GUI component indicating more priority on speed than the current image quality adjustment information. The button 32b is a GUI component indicating more priority on image quality of a reconstruction image than the current image quality adjustment information. The button 32c is a GUI component for indicating confirmation of the current image quality adjustment information. The user can confirm the image quality adjustment information by repeatedly pressing the buttons 32a and 32b until appropriate reconstruction image and reconstruction period are obtained and finally pressing the button 32c.

An information processing method executed in a case where the image quality adjustment information is set on such a GUI is described with reference to FIG. 13. FIG. 13 is a flowchart of the information processing method according to the present modification. Note that steps S110 to S160 in FIG. 13 are similar to those in FIG. 4, and therefore description thereof is omitted. The following describes steps S310 to S350 executed after step S160.

In a case where the button 32b is pressed (Yes in S310), the image quality adjustment information is updated so that the value of the degree of priority of image quality (the first degree of priority) increases, that is, the value of the degree of priority of speed (the second degree of priority) decreases (S320), and the processing returns to step S140.

In a case where the button 32b has not been pressed (No in S310) and the button 32a has been pressed (Yes in S330), the image quality adjustment information is updated so that the value of the degree of priority of image quality decreases, that is, the value of the degree of priority of speed increases (S340), and the processing returns to step S140.

In a case where the button 32b has not been pressed (No in S310) and the button 32a has not been pressed (No in S330) and the button 32c has been pressed (Yes in S350), the information processing method ends. In a case where the button 32b has not been pressed (No in S310) and the button 32a has not been pressed (No in S330) and the button 32c has not been pressed (No in S350), the processing returns to step S310.

As described above, according to the GUI according to the present modification, the image quality adjustment information can be updated by repeatedly pressing the two buttons 32a and 32b, and it is therefore easier to finely adjust the values of the arithmetic parameters. As a result, reconstruction calculation of compressed sensing can be more effectively performed.

### Modification 5

Next, Modification 5 of the embodiment is described. The present modification is mainly different from the above embodiment in that information indicative of color reproducibility in four or more spectral images is used instead of the degree of priority of speed (the first degree of priority) and the degree of priority of image quality (the second degree of priority). The following mainly describes differences regarding a GUI and related processing according to the present modification from the above embodiment with reference to FIG. 5.

On the GUI according to the present modification, a “COLOR REPRODUCIBILITY: LOW” label and a “COLOR REPRODUCIBILITY: HIGH” label are displayed instead of the “PRIORITY ON SPEED” label and the “PRIORITY ON IMAGE QUALITY” label of FIG. 5. Therefore, in a case where the indicator 30a is located at a left end, the slider 30 sets image quality adjustment information indicative of lowest color reproducibility. On the other hand, in a case where the indicator 30a is located at a right end, the slider 30 sets image quality adjustment information indicative of highest color reproducibility.

The parameter determination unit 230 can determine the value of the first parameter corresponding to the degree of influence of regularization so that the degree of influence of regularization becomes higher as the color reproducibility becomes higher. Furthermore, the parameter determination unit 230 can determine the value of the second parameter corresponding to the number of iterations so that the number of iterations becomes larger as the color reproducibility becomes higher. Conversely, the parameter determination unit 230 can determine the value of the first parameter so that the degree of influence of regularization becomes lower as the color reproducibility becomes lower. Furthermore, the parameter determination unit 230 can determine the value of the second parameter so that the number of iterations becomes smaller as the color reproducibility becomes lower.

As described above, according to the GUI according to the present modification, the values of the arithmetic parameters can be determined by setting color reproducibility. The color reproducibility depends on the degree of influence of regularization and the number of iterations. For example, the color reproducibility becomes higher as the degree of influence of regularization becomes lower. Therefore, reconstruction calculation of compressed sensing can be more effectively performed by determining the values of the arithmetic parameters on the basis of the color reproducibility.

### Modification 6

Next, Modification 5 of the embodiment is described. The present modification is mainly different from the above embodiment in that information indicative of a size of a structure of a subject in four or more spectral images is used instead of the degree of priority of speed (the first degree of priority) and the degree of priority of image quality (the second degree of priority). The following mainly describes differences regarding a GUI and related processing according to the present modification from the above embodiment with reference to FIG. 5.

On the GUI according to the present modification, a “STRUCTURE SIZE: SMALL” label and a “STRUCTURE SIZE: LARGE” label are displayed instead of the “PRIORITY ON SPEED” label and the “PRIORITY ON IMAGE QUALITY” label of FIG. 5. Therefore, in a case where the indicator 30a is located at a left end, the slider 30 sets image quality adjustment information indicative of a smallest structure size. On the other hand, in a case where the indicator 30a is located at a right end, the slider 30 sets image quality adjustment information indicative of a largest structure size.

The parameter determination unit 230 can determine the value of the first parameter corresponding to the degree of influence of regularization so that the degree of influence of regularization becomes lower as the structure size becomes smaller. Furthermore, the parameter determination unit 230 can determine the value of the second parameter corresponding to the number of iterations so that the number of iterations becomes larger as the structure size becomes smaller. Conversely, the parameter determination unit 230 can determine the value of the first parameter so that the degree of influence of regularization becomes higher as the structure size becomes larger. Furthermore, the parameter determination unit 230 can determine the value of the second parameter so that the number of iterations becomes smaller as the structure size becomes larger.

As described above, according to the GUI according to the present modification, the values of the arithmetic parameters can be determined by setting the structure size. For appropriate reconstruction of a structure, it is necessary to determine the degree of influence of regularization and the number of iterations according to the size of the structure. For example, a structure having a smaller size can be generated as the degree of influence of regularization becomes lower. Therefore, reconstruction calculation of compressed sensing can be more effectively performed by determining the values of the arithmetic parameters on the basis of the structure size.

### OTHER EMBODIMENTS

Although the information processing method has been described above on the basis of the embodiment and modifications, the information processing method according to the present disclosure is not limited to the above embodiment and modifications. Other embodiments realized by combining any constituent elements in the above embodiment and modifications and modifications obtained by applying various variations that occur to a person skilled in the art to the above embodiment and modifications without departing from the spirit of the present disclosure are also encompassed within the present disclosure.

For example, the above embodiment, Modification 5, and Modification 6 may be combined in any way. That is, the image quality adjustment information may include any combination of a value of the degree of priority of image quality, a value of the degree of priority of speed, a value of color reproducibility, and a value of the structure size.

Note that although a hyperspectral image is defined as an image including four or more spectral images in the above embodiment and modifications, a hyperspectral image may be defined as an image including five or more spectral images, six or more spectral images, seven or more spectral images, eight or more spectral images, nine or more spectral images, or ten or more spectral images.

Although the filter array 130 is used as an encoding element in the imaging device 100 according to the above embodiment and modifications, this is not restrictive. For example, the meta-lens described in “Establishing a World-First Technology for Capturing Hyperspectral Images and Videos by Combining Meta-lens and AI with Ordinary Digital Cameras—Turning an “ordinary camera” into a “camera that can see the nature of things” through the fusion of optical technology and AI-”, [online], Oct. 24, 2022, Nippon Telegraph and Telephone Corporation, [retrieved on Jun. 15, 2023], Internet <URL: https://group.ntt/jp/newsrelease/2022/10/24/221024a.html> (hereinafter referred to as Non Patent Literature 1) may be used instead of the filter array 130 according to the above embodiment and modifications. For example, the CMOS image sensor described in Ahasan Ahamed, et. al., “Reconstruction-based spectroscopy using CMOS image sensors with random photon-trapping nanostructure per sensor”, Proc. SPIE 11971, High-Speed Biomedical Imaging and Spectroscopy VII, 1197106, 2 Mar. 2022 (hereinafter referred to as Non Patent Literature 2) may be used instead of the filter array 130 and the image sensor 120 according to the above embodiment and modifications.

Although the information processing method according to the above embodiment and modifications is applied to compressed sensing of a hyperspectral image, this is not restrictive. For example, the information processing method according to the above embodiment and modifications may be applied to compressed sensing of a high dynamic range image, a temporal super-resolution image, or a multi-view camera image.

For example, in a case where the information processing method according to the above embodiment and modifications is applied to compressed sensing of a high dynamic range image, the values of the parameters used in calculation of the formula (1) disclosed in Ana Serrano, et. al., “Convolutional Sparse Coding for High Dynamic Range Imaging”, Computer Graphics Forum Volume 35, Issue 2, pp. 153-163, 27 May 2016 (hereinafter referred to as Non Patent Literature 3) may be determined on the basis of the image quality adjustment information. In this case, F in the formula (1) of Non Patent Literature 3 corresponds to τ in the formula (2) of the present disclosure. Note that a compressed image of a high dynamic range image can be, for example, obtained by changing an exposure period for each pixel by using Liquid Crystal on Silicon (LCoS) and a beam splitter. For example, the compressed image may be obtained by installing ND filters having different transmittances in respective pixels. In the compressed image thus obtained, the pixels are different in exposure period or amount of transmitted light.

For example, in a case where the information processing method according to the above embodiment and modifications is applied to compressed sensing of a temporal super-resolution image, the values of the parameters used in calculation of the formula (3) disclosed in Toshiki Sonoda, et. al., “High-Speed Imaging using CMOS Image Sensor with Quasi Pixel-Wise Exposure”, Proceedings of IEEE International Conference on Computational Photography (ICCP), pp. 1-11, May 2016 (hereinafter referred to as Non Patent Literature 4) may be determined on the basis of the image quality adjustment information. In this case, F in the formula (3) of Non Patent Literature 4 corresponds to t in the formula (2) of the present disclosure. Note that a compressed image of a temporal super-resolution image can be, for example, obtained by changing an exposure pattern in one frame per pixel by using a special CMOS sensor or LCoS. In the compressed image thus obtained, exposure patterns of coded exposure in pixels are different from each other.

For example, in a case where the information processing method according to the above embodiment and modifications is applied to compressed sensing of a multi-view image, the values of the parameters used in calculation of the formula (6) disclosed in Japanese Unexamined Patent Application Publication No. 2018-26781 (hereinafter referred to as Patent Literature 3) may be determined on the basis of the image quality adjustment information. In this case, λ in the formula (8) of Patent Literature 3 corresponds to T in the formula (2) of the present disclosure. Note that a compressed image of a multi-view image can be, for example, obtained by receiving, by a single image sensor, images from viewpoints through a mask having transmittance that differs on a pixel-by-pixel basis. In the compressed image thus obtained, data of each of the pixels includes image information from viewpoints.

The present disclosure is applicable to image reconstruction using compressed sensing.

What is claimed is:

1. An information processing method executed by a computer, the information processing method comprising:
acquiring a compressed image including pixels each having data including information on four or more wavelength bands;
acquiring image quality adjustment information for adjusting image quality of four or more spectral images that are generated by executing reconstruction calculation based on the compressed image and correspond to the four or more wavelength bands, respectively;
determining one or more values of one or more arithmetic parameters used in the reconstruction calculation on a basis of the image quality adjustment information; and
generating the four or more spectral images by executing the reconstruction calculation on the compressed image by using the determined values of the arithmetic parameters.

2. The information processing method according to claim 1, further comprising displaying a graphical user interface for acquiring the image quality adjustment information, wherein
the image quality adjustment information is acquired via the graphical user interface.

3. The information processing method according to claim 2, further comprising displaying the compressed image and the generated four or more spectral images.

4. The information processing method according to claim 3, further comprising displaying a period required for the reconstruction calculation.

5. The information processing method according to claim 1, wherein
the image quality adjustment information includes a value of a first degree of priority that is a degree of priority of image quality of the four or more spectral images, a value of a second degree of priority that is a degree of priority of speed of the reconstruction calculation, or a combination of the value of the first degree of priority and the value of the second degree of priority.

6. The information processing method according to claim 5, wherein
the arithmetic parameters include a first parameter that corresponds to a degree of influence of regularization in the reconstruction calculation.

7. The information processing method according to claim 6, wherein
a value of the first parameter is determined so that the degree of influence of the regularization becomes lower as the first degree of priority becomes higher or as the second degree of priority becomes lower.

8. The information processing method according to claim 5, wherein
the arithmetic parameters include a second parameter that corresponds to the number of iterations of iterative operation included in the reconstruction calculation.

9. The information processing method according to claim 8, wherein
a value of the second parameter is determined so that the number of iterations becomes larger as the first degree of priority becomes higher or as the second degree of priority becomes lower.

10. The information processing method according to claim 1, wherein
the image quality adjustment information includes at least one of information indicative of color reproducibility in the four or more spectral images or information indicative of a size of a structure of a subject in the four or more spectral images.

11. The information processing method according to claim 1, wherein
the arithmetic parameters include a first parameter that corresponds to a degree of influence of regularization in the reconstruction calculation, and
a value of the first parameter is determined on a basis of an average luminance value of the compressed image and the image quality adjustment information.

12. An information processing apparatus comprising:
an image acquirer that acquires a compressed image including pixels each having data including information on four or more wavelength bands;
an information acquirer that acquires image quality adjustment information for adjusting image quality of four or more spectral images that are generated by executing reconstruction calculation based on the compressed image and correspond to the four or more wavelength bands, respectively;
a parameter determiner that determines one or more values of one or more arithmetic parameters used in the reconstruction calculation on a basis of the image quality adjustment information; and
a reconstruction calculator that generates the four or more spectral images by executing the reconstruction calculation on the compressed image by using the determined values of the arithmetic parameters.
